(19) United States
(12) Patent Application Publication
(10) Pub. No.: US 2010/0302002 A1
(43) Pub. Date: Dec. 2, 2010

(54) Method for Monitoring Main Machine, Monitoring Apparatus and Main Machine

(75) Inventors: Deying Guo, Shenzhen (CN); Jun Li, Shenzhen (CN); Wei Zhang, Shenzhen (CN); Penghui Yang, Shenzhen (CN); Jianrong Ye, Shenzhen (CN); Huaxing Chen, Shenzhen (CN); Zuohua Zhou, Shenzhen (CN); Dengke Wang, Shenzhen (CN); Chundong Fang, Shenzhen (CN); Yantao Zhao, Shenzhen (CN); Bijun Zhang, Shenzhen (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Yulong Computer Telecommunication Technologies (Shenzhen) Co., Ltd., Shenzhen (CN)

(21) Appl. No.: 12/848,902

(22) Filed: Aug. 2, 2010

Related U.S. Application Data
(63) Continuation of application No. PCT/CN2009/070188, filed on Jan. 16, 2009.

(30) Foreign Application Priority Data
Feb. 2, 2008 (CN) 200810065217.5
Feb. 2, 2008 (CN) 200820091929.X
Feb. 15, 2008 (CN) 200810066097.0
May 27, 2008 (CN) 200820048346.9
Jun. 4, 2008 (CN) 200810028530.1
Jul. 1, 2008 (CN) 200810029166.0
Aug. 5, 2008 (CN) 200810030017.6

(51) Int. Cl. G08B 5/22

(52) U.S. Cl. 340/7.2

(57) ABSTRACT

A method for monitoring a main machine, a monitoring apparatus and a main machine are provided. The method for monitoring the main machine includes paging, by a monitoring apparatus, a main machine within an effective area, returning, by a main machine being paged, apparatus information of the main machine; determining at least one main machine as a monitored main machine according to the apparatus information returned by the at least one main machine; establishing a monitoring connection relationship with each monitored main machine; and monitoring an emergent event of the at least one monitored main machine or inquiring about a working status of the at least one monitored main machine by using the monitoring connection relationship established.

### CROSS-REFERENCE TO RELATED APPLICATIONS

This application is a Continuation of International Patent Application No. PCT/CN2009/070188, filed on Jan. 16, 2009, which claims priority to Foreign Patent Application Nos. CN 200810065217.5, filed on Feb. 2, 2008, CN 200820091929.X, filed on Feb. 2, 2008, CN 200810066097.0, filed on Feb. 15, 2008, CN 200820048346.9, filed on May 27, 2008, CN 200810028530.1, filed on Jun. 4, 2008, CN 200810029166.0, filed on Jul. 1, 2008, and CN 200810030017.6, filed on Aug. 5, 2008, the disclosures of which are incorporated herein by reference in their entirety.

### FIELD OF THE INVENTION

The present invention relates to communications field, and more particularly, to a method for monitoring a main machine, a monitoring apparatus and a main machine.

### BACKGROUND OF THE INVENTION

With progresses of technologies, more and more electronic apparatuses emerge, such as cell phones, digital cameras, laptops, palm computers, etc. These electronic apparatuses have becoming indispensable personal belongings in people's life. But these electronic apparatuses are usually large and heavy, and emit radiations which harm people's body when being used. Therefore, these electronic apparatuses are usually put in a bag or a pocket of trousers which are away from head, or put in somewhere in office or home away from the body, which makes the usage of the electronic apparatuses very inconvenient. Some important calls or short messages may be missed, especially in noisy places or outdoors or when listening to MP3 music.

In addition, with the increasing of the number of the electronic apparatuses, if multiple kinds of such electronic apparatuses are carried, it is necessary to check a working status or to process an emergent event of each electronic apparatus one by one, such as answering a phone call, viewing an email in a laptop and viewing photos in a digital camera. The monitoring and processing operations cannot be centralized performed through one portable mobile terminal, thus are rather troublesome.

Therefore, there is an urgent need to provide a technique or a product to help a user to monitor the status of one or more electronic apparatuses, so as to enable the user to know the status of each electronic apparatus conveniently, timely and accurately.

### SUMMARY OF THE INVENTION

Embodiments of the present invention provide a method for monitoring a main machine, a monitoring apparatus and a main machine, so as to monitor the main machine.

According to an embodiment of the present invention, a method for monitoring a main machine is provided. The method includes paging by a monitoring apparatus, a main machine within an effective area, receiving, by the monitoring apparatus, from a main machine being paged, apparatus information of the main machine; determining at least one main machine as a monitored main machine according to the apparatus information returned by the at least one main machine; establishing a monitoring connection relationship with each monitored main machine; and monitoring an emergent event of the at least one monitored main machine or inquiring about a working status of the at least one monitored main machine, by using the monitoring connection relationship established.

According to another embodiment of the present invention, a monitoring apparatus is provided. The monitoring apparatus includes: a control module, a communication module and an inquiring module; wherein the control module is adapted to control communication between the communication module and the inquiring module; the communication module is adapted to establish a monitoring connection relationship with a monitored main machine; and the inquiring module is adapted to transmit, during establishment of the monitoring connection relationship with the monitored main machine, a searching command and a request requesting the monitored main machine to return apparatus information of the monitored main machine to the monitored main machine, and adapted to monitor, after the monitoring connection relationship is established with the monitored main machine, an emergent event of the monitored main machine or inquire about a working status of the monitored main machine.

According to still another embodiment of the present invention, a main machine is provided. The main machine includes: a communication module, a detecting module and a response control module; wherein the communication module is adapted to establish a monitoring connection relationship with a monitoring apparatus performing a monitoring task; the detecting module is adapted to detect, during establishment of the monitoring connection relationship with the monitoring apparatus, whether a searching command is transmitted by the monitoring apparatus, and adapted to detect, after the establishment of the monitoring connection relationship with the monitoring apparatus, whether a monitored event inquiring list is received from the monitoring apparatus or whether there is an emergent event happens in the main machine; and the response control module is adapted to transmit apparatus information of the main machine to the monitoring apparatus through the communication module when the detecting module detects the searching command transmitted by the monitoring apparatus, inquire about and collect working status information of the main machine and transmit the working status information to the monitoring apparatus through the communication module when the detecting module detects that the monitored event inquiring list is received from the monitoring apparatus, or transmit emergent event information to the monitoring apparatus through the communication module when the detecting module detects that the emergent event happens in the main machine.

In the method for monitoring the main machine, the monitoring apparatus and the main machine provided by the embodiments of the present invention, when the monitoring apparatus is to monitor a main machine, the monitoring apparatus firstly pages the main machine within the effective area to request the main machine to return apparatus information of the main machine. Once the main machine returns the apparatus information of the main machine, the monitoring apparatus is able to determine the main machine according to the apparatus information returned by the main machine and establish a monitoring connection relationship with the main machine. After establishing the monitoring connection relationship with the main machine, the monitoring apparatus can monitor an emergent event of the main machine and inquire about a working status of the monitored main machine.

### BRIEF DESCRIPTION OF THE DRAWINGS

FIG. 1 is a flowchart illustrating a method for monitoring a main machine by a child machine according to an embodiment of the present invention.

FIG. 2 is flowchart illustrating monitoring operations executed at a main machine side in a main machine reporting manner according to an embodiment of the present invention.

FIG. 3 is a flowchart illustrating monitoring operations executed at a child machine side in the main machine reporting manner according to an embodiment of the present invention.

FIG. 4 is a flowchart illustrating monitoring operations executed at the main machine side in a child machine inquiring manner according to an embodiment of the present invention.

FIG. 5 is a flowchart illustrating monitoring operations executed at the child machine side in the child machine inquiring manner according to an embodiment of the present invention.

FIG. 6 is a schematic diagram illustrating a system for monitoring a main machine by a child machine according to an embodiment of the present invention.

FIG. 7 is a block diagram illustrating a structure of a child machine according to an embodiment of the present invention.

FIG. 8 is a schematic diagram illustrating a display of a child machine according to an embodiment of the present invention.

FIG. 9 is a block diagram illustrating a structure of a main machine according to an embodiment of the present invention.

FIG. 10 is a flowchart illustrating a method for dynamically configuring a monitored event menu by a child machine according to an embodiment of the present invention.

FIG. 11 is a block diagram illustrating a structure of a child machine according to an embodiment of the present invention.

FIG. 12 is a block diagram illustrating a structure of a main machine according to an embodiment of the present invention.

FIG. 13 is a flowchart illustrating a method of communication authentication between a main machine and a child machine according to an embodiment of the present invention.

FIG. 14 is a flowchart illustrating a procedure of binding a main machine with a child machine according to an embodiment of the present invention.

FIG. 15 is a flowchart illustrating configuring of communication authentication permission by a main machine for a child machine according to an embodiment of the present invention.

FIG. 16 is a schematic diagram illustrating an interface of selecting to granting permission to a child machine by a main machine according to an embodiment of the present invention.

FIG. 17 is a flowchart illustrating a method of communication authentication between a child machine and a main machine during the calling of the child machine according to an embodiment of the present invention.

FIG. 18 is a block diagram illustrating a structure of a main machine according to an embodiment of the present invention.

FIG. 19 is a block diagram illustrating a structure of a child machine for monitoring a status of a cell phone according to a first embodiment of the present invention.

FIG. 20 is a block diagram illustrating a structure of a child machine for monitoring a status of a cell phone according to a second embodiment of the present invention.

FIG. 21 is a block diagram illustrating a structure of a child machine for monitoring a status of a cell phone according to a third embodiment of the present invention.

FIG. 22 is a flowchart illustrating a method for monitoring a status of a cell phone according to a first embodiment of the present invention.

FIG. 23 is a flowchart illustrating a method for monitoring a status of a cell phone according to a second embodiment of the present invention.

FIG. 24 is a block diagram illustrating a structure of a multimedia player according to a first embodiment of the present invention.

FIG. 25 is a block diagram illustrating a structure of a multimedia player according to a second embodiment of the present invention.

FIG. 26 is a block diagram illustrating a structure of a multimedia player according to a third embodiment of the present invention.

FIG. 27 is a flowchart illustrating a method for monitoring a cell phone and playing a cell phone audio file by a multimedia player according to an embodiment of the present invention.

### DETAILED DESCRIPTION OF THE INVENTION

The present invention will be described in detail hereinafter with reference to accompanying drawings and embodiments for a more explicit explanation of the object, technical solution and merits of the present invention.

In a method for monitoring a main machine provided by an embodiment of the present invention, a monitoring apparatus pages a main machine within an effective area to request the main machine to return apparatus information of the main machine, determines at least one main machine as a monitored main machine according to the apparatus information returned by the at least one main machine, respectively establishes a monitoring connection relationship with the at least one monitored main machine, and monitors an emergent event of the at least one monitored main machine and inquires about a working status of the at least one monitored main machine by using the established monitoring connection relationship.

In a method for monitoring a main machine provided by another embodiment of the present invention, a monitoring apparatus, according to monitored functional item information of each monitored main machine, monitors an emergent event corresponding to the monitored functional item information of the monitored main machine and inquires about a working status corresponding to the monitored functional item information of the monitored main machine.

In a method for monitoring a main machine by a child machine provided by an embodiment of the present invention, a monitoring apparatus establishes a monitoring connection relationship with one or more monitored main machines, and implements, respectively by using the monitoring connection relationship established with the one or more monitored main machines, a multi-monitoring operation including processing an emergent event of the one or more monitored main machines and inquiring about a working status of the one or more monitored main machines through a main machine reporting manner or a child machine inquiring manner.

In embodiments of the present invention, the main machine may be existing electronic apparatuses which have multiple functions, e.g., a laptop, a palm computer, an intelligent cell phone which are equipped with monitoring functional modules or a digital camera with a communication capability. The monitoring apparatus may be a simple and portable electronic apparatus, e.g. a mobile communication electronic product such as a multimedia player, used for monitoring other main machines. Hereinafter, the monitoring apparatus is also referred to as a child machine in accordance with the main machine.

But those skilled in the art should know that the “main machine” and the “child machine” in the embodiments of the present invention may be two independent terminal apparatuses. In addition, in practical applications, one terminal apparatus may act as a main machine and is monitored by another terminal apparatus in one scenario, but acts as a child machine and monitors other terminal apparatuses in another scenario.

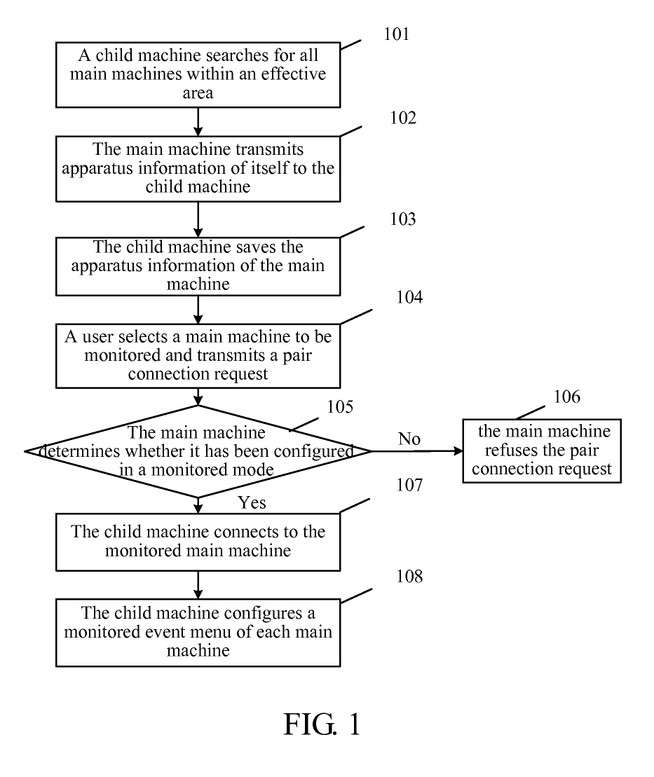

FIG. 1 is a flowchart illustrating a method for monitoring a main machine by a child machine according to an embodiment of the present invention. As shown in FIG. 1, the method includes the following steps.

Step 101, a child machine searches for a main machine within an effective area, and transmits a request requesting the main machine to return apparatus information of the main machine. At this time, all main machines will be found by the child machine as long as the main machines are within the effective area and have started their communication modules. The child machine communicates with each main machine according to a uniform and common command which will not let contents of the main machine out.

Step 102, the main machine being searched out transmits apparatus information of itself to the child machine; the apparatus information may include an apparatus type or an apparatus number, e.g. the apparatus type or the apparatus number is used for indicating whether the main machine is a laptop or an intelligent cell phone.

Step 103, the child machine saves the apparatus information of the main machine, so as to identify each main machine and therefore communicate with the main machine.

Step 104, a user selects a main machine to be monitored through the child machine, and transmits a pair connection request to the main machine to be monitored at the same time. The “pair connection” herein may also be referred to as a “monitoring connection” in the following.

Step 105, after receiving the pair connection request, the main machine to be monitored determines whether the main machine has been configured as a monitored mode. If the main machine has been configured as the monitored mode, step 107 is performed; otherwise, step 106 is performed.

Step 106, the main machine to be monitored refuses the pair connection request of the child machine. The procedure is ended.

Step 107, the main machine accepts the pair connection request of the child machine and returns a connection response signal to the child machine. After receiving the connection response signal, the child machine connects to the main machine to the monitored.

Step 108, the child machine establishes a monitoring connection relationship with the main machine to be monitored and configures a monitored event menu of the main machine to be monitored, and the procedure is ended.

After the monitoring connection relationship is established, when an emergent event being monitored happens in the monitored main machine, a monitoring operation may be performed by using a main machine reporting manner. The emergent event being monitored may be different with respect to different types of the monitored main machines. For example, for an intelligent cell phone, the emergent event may be a user call, a new short message, and an alarm clock prompt, etc.; for a laptop, the emergent event may be a new email, system regular start or shut down, etc. Those skilled in the art should know that, the monitored event menu configured for the monitored main machine includes monitored functional item information of the monitored main machine. During the procedure of monitoring the main machine by the child machine, the child machine monitors the main machine based on the monitored functional item information of the main machine.

Those skilled in the art should also know that, the monitored event menu is actually a kind of man-machine operation interface, and is used for display the monitored functional item information of the monitored main machine, and emergent event information and work status which are correspond to the monitored functional item information and are returned by the monitored main machine to the user.

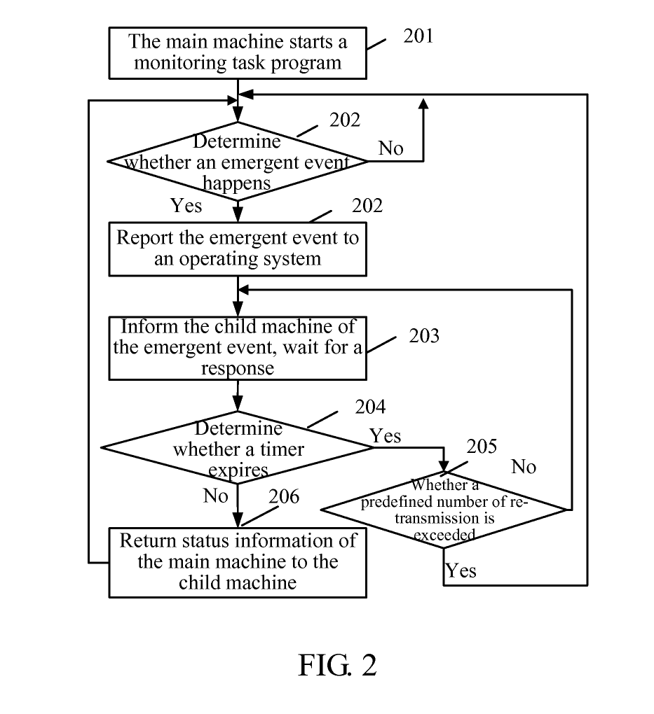

FIG. 2 is a flowchart illustrating monitoring operations executed at a main machine side in a main machine reporting manner according to an embodiment of the present invention. As shown in FIG. 2, when the main machine reporting manner is adopted, the monitoring operations executed at the main machine side include the following steps.

Step 201, a main machine starts a monitoring task program according to contents of a monitored event menu.

Step 202, the main machine determines whether an emergent event happens. If no emergent event happens, the monitoring task program turns to be executed in background. If an emergent event happens, the monitoring task program reports the emergent event to an operating system.

Step 203, the main machine transmits the emergent event and apparatus information of the main machine to a child machine for processing, and waits for the child machine to return a process result.

Step 204, the main machine determines whether a timer expires before the child machine returns the process result. If the timer expires, step 205 is performed; otherwise, step 206 is performed.

Step 205, the main machine transmits the emergent event to the child machine again. If the emergent event is not transmitted successfully within a predefined number of re-transmissions, the main machine gives up the transmission of the emergent event, and returns to step 202 to wait for a next emergent event.

Step 206, the main machine returns status information of the main machine to the child machine. Thus, the main machine completes the report of the current emergent event and returns to step 202 to wait for a next emergent event.

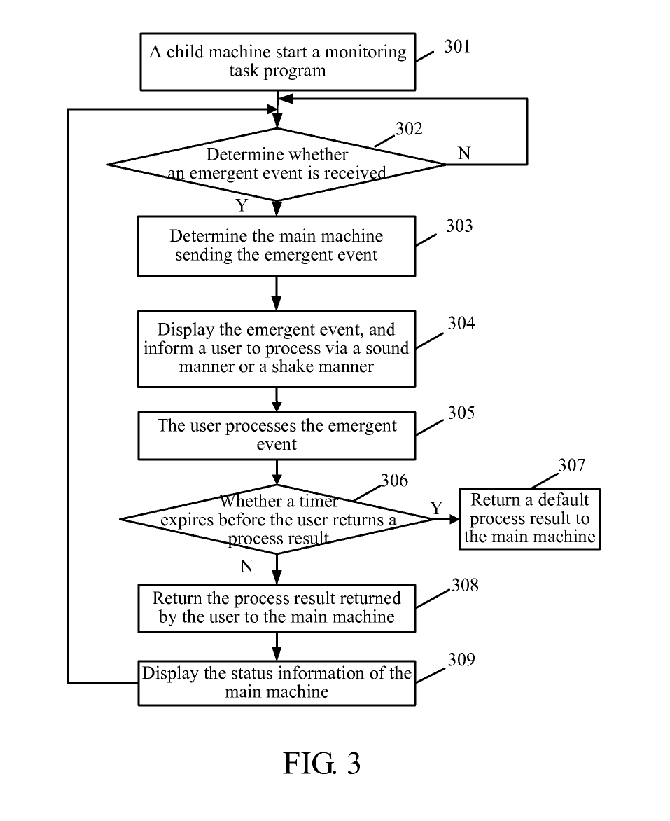

FIG. 3 is a flowchart illustrating monitoring operations executed at a child machine side in the main machine reporting manner according to an embodiment of the present invention. As shown in FIG. 3, when the main machine reporting manner is adopted, the monitoring operations executed at the child machine side include the following steps.

Step 301, a child machine starts a monitoring task program.

Step 302, the child machine determines whether an emergent event is received from a monitored main machine.

Step 303, the child machine determines the monitored main machine sending the emergent event according to apparatus information of the main machine which is received together with the emergent event.

If the whole monitoring system includes only one child machine and one monitored main machine, the emergent event received by the child machine must be from the monitored main machine. Thus, step 303 may be omitted and step 304 may be executed directly.

Step 304, the child machine displays the emergent event received and informs a user to process the emergent event via a sound manner or a shake manner.

When the child machine monitors multiple main machines, the child machine may configure a page for each main machine. Once an emergent event of a certain main machine is received, the emergent event is displayed on the page corresponding to the main machine. Thus, the user is prompted more apparently.

Step 305, the child machine waits for the user to input a process result to the emergent event.

Step 306, the child machine determines whether a timer expires before the user returns the process result. If the timer expires, step 307 is performed; otherwise, step 308 is performed.

Step 307, the child machine returns a default process result to the monitored main machine corresponding to the emergent event. After this step, the procedure may be ended directly or step 309 is performed.

Step 308, the child machine sends the process result returned by the user to the monitored main machine corresponding to the emergent event.

Step 309, the child machine displays the received status information of the monitored main machine, e.g. displays the received status information on the page corresponding to the monitored main machine. Thus, the child machine finishes the processing of the current emergent event and returns to step 302 to wait for a next emergent event.

When the child machine is to inquire about a working status of the monitored main machine, a child machine inquiring manner may be adopted to complete the monitoring operation. The working status to be inquired about may be different with respect to different types of monitored main machines. For example, as to an intelligent cell phone, the working status to be inquired about may be signal intensity, incoming call number, remained power, etc.; as to a digital camera, the working status to be inquired about may be storage space, remained power, etc.

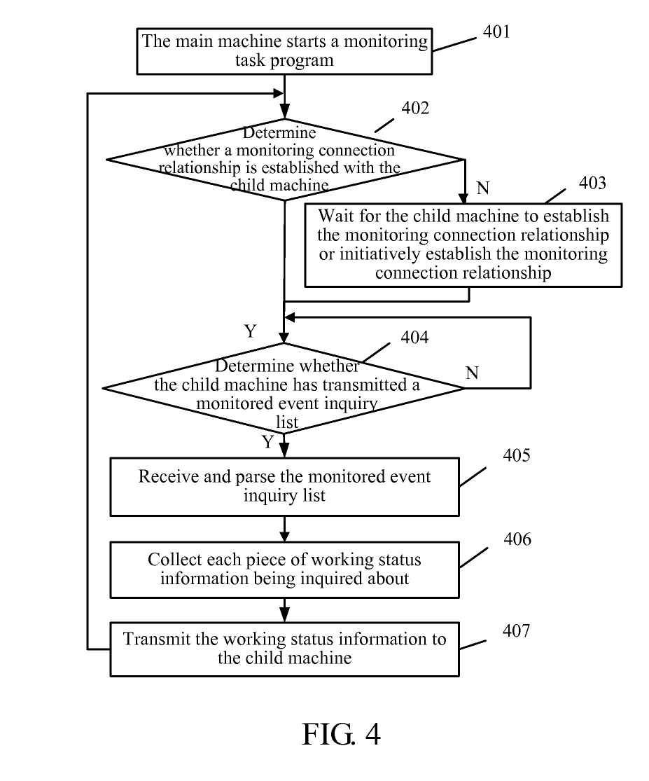

FIG. 4 is a flowchart illustrating monitoring operations executed at a main machine side in a child machine inquiring manner according to an embodiment of the present invention. As shown in FIG. 4, when the child machine inquiring manner is adopted, the monitoring operations executed at the main machine side include the following steps.

Step 401, a main machine starts a monitoring task program.

Step 402, the main machine determines whether the main machine has established a monitoring connection relationship with a child machine. If the main machine has established a monitoring connection relationship with a child machine, step 404 is performed; otherwise, step 403 is performed.

Step 403, the main machine waits for the child machine to establish the monitoring connection relationship or initiatively establish the monitoring connection relationship.

Step 404, the main machine determines whether the child machine has transmitted a monitored event inquiring list. If the child machine has transmitted the monitored event inquiring list, step 405 is performed.

Step 405, the main machine receives and parses the monitored event inquiring list.

Step 406, the main machine collects working status information being inquired about according to the monitored event inquiring list received.

Step 407, the main machine transmits the obtained working status information to the child machine after packaging the obtained working status information. Now, the current inquiry ends, and the main machine returns to step 402 to wait for a next inquiry.

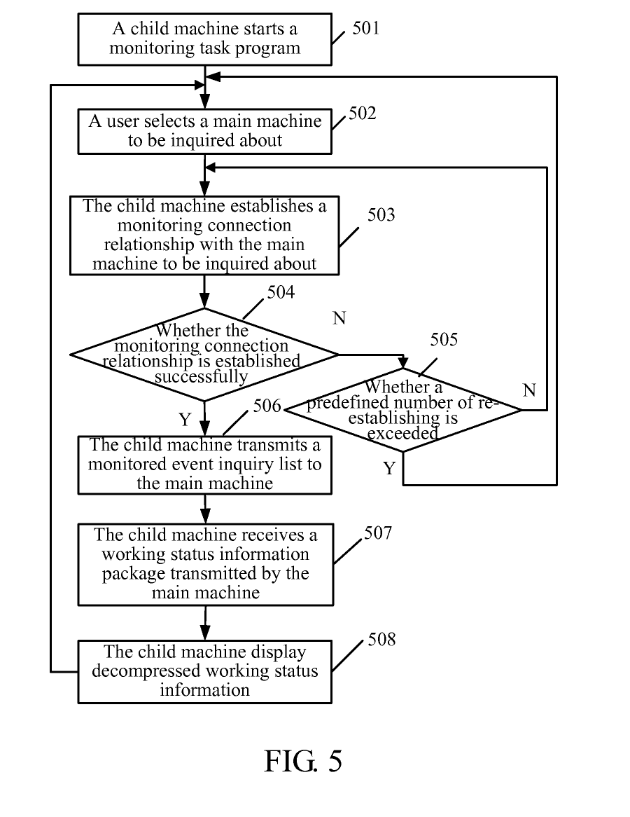

FIG. 5 is a flowchart illustrating monitoring operations executed at a child machine side in the child machine inquiring manner according to an embodiment of the present invention. As shown in FIG. 5, when the child machine inquiring manner is adopted, the monitoring operations executed at the child machine side include the following steps.

Step 501, a monitoring task program of a child machine is started according to a user's requirement.

Step 502, a main machine to be inquired about is selected according to the user's requirement.

Step 503, the child machine establishes a monitoring connection relationship with the main machine to be inquired about.

Step 504, the child machine determines whether the monitoring connection relationship is established successfully, if the monitoring connection relationship is established successfully, step 506 is performed; otherwise, step 505 is performed.

Step 505, the child machine re-establishes the monitoring connection relationship with the main machine to be inquired about. If the monitoring connection relationship is not successfully established within a predefined number of re-establishing, the child machine returns to step 502.

Step 506, the child machine transmits a monitored event inquiring list to the main machine.

Step 507, the child machines receive a working status information package from the main machine.

Step 508, the child machine decompresses the working status information package received, and displays working status information of the main machine being inquired about for the user. For example, the child machine may display the working status information of the main machine being inquired about on a page corresponding to the main machine being inquired about. Now, the current inquiry ends, and the child machine returns to step 502 to wait for a next inquiry.

Based on the method for monitoring the main machine by the child machine provided by the embodiments of the present invention, the main machine is monitored by an independent child machine, which facilitates operations and enhances a man-machine interaction performance.

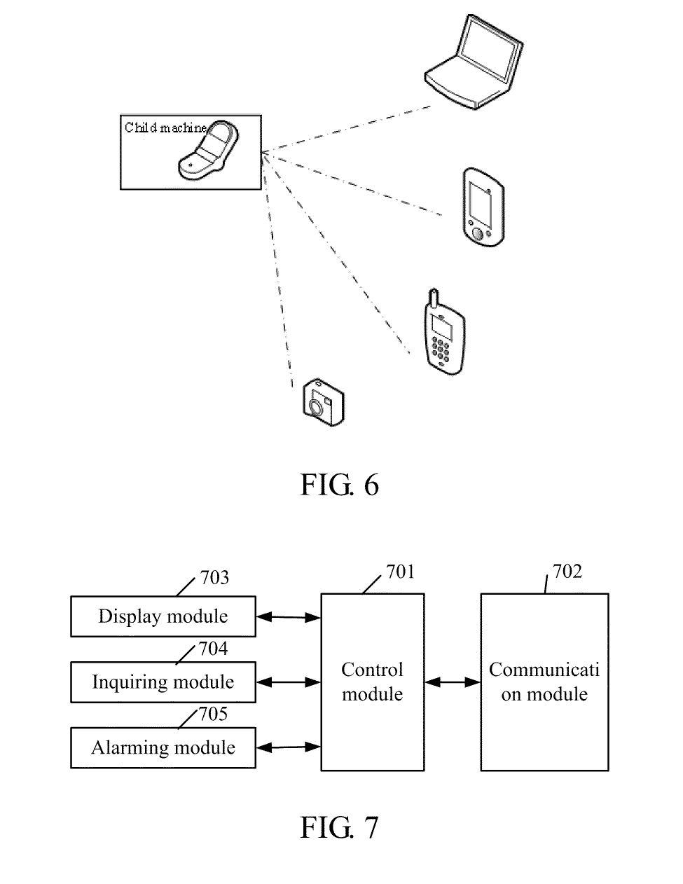

Accordingly, embodiments of the present invention also provide a system for monitoring a main machine by a child machine. The system includes a single child machine and at least one main machine. The single child machine implements a centralized monitoring and a simply control to the at least one main machine through a wire or a wireless network according to the methods provided by the above embodiments of the present invention. A detailed structure of the system is shown in FIG. 6.

Embodiments of the present invention also provide another system for monitoring a main machine by a child machine. The system includes at least one child machine and a single main machine. Each child machine may implement monitoring and simple control to the main machine through a wire or a wireless network according to the methods provided by the above embodiments of the present invention.

Accordingly, embodiments of the present invention further provide internal structures of the main machine and the child machine in the system for monitoring the main machine by the child machine. FIG. 7 is a block diagram illustrating a structure of a child machine according to an embodiment of the present invention. As shown in FIG. 7, the child machine in this embodiment includes a control module 701, a communication module 702, a display module 703, an inquiring module 704 and an alarming module 705. The communication module 702, the display module 703, the inquiring module 704 and the alarming module 705 are respectively electrically connected to the control module 701.

The control module 701 is adapted to control communications between modules inside the child machine.

When the child machine further includes an inputting module, the control module 701 is further adapted to process information inputted by a user through the inputting module (e.g. keyboard operation).

The communication module 702 is adapted to establish a monitoring connection relationship with a monitored main machine, transmit and receive information.

The display module 703 is adapted to display working status information or emergent event information returned by the monitored main machine.

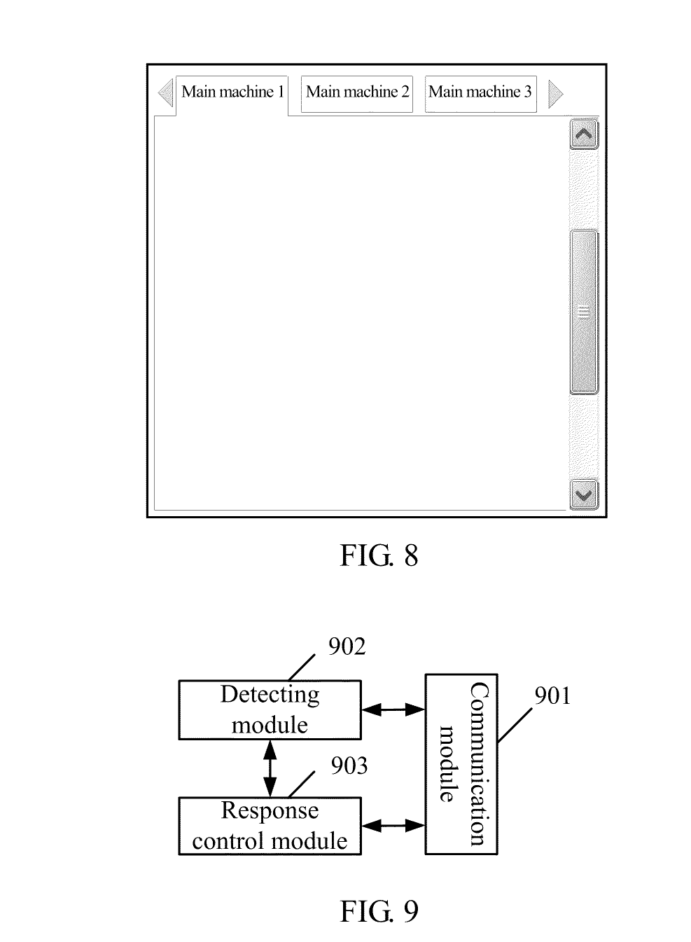

Generally, the display module 703 may be a display and may respectively display monitored information of monitored main machines according to names of the monitored main machines, i.e. display the monitored information of each monitored main machine on an independent page. FIG. 8 is a schematic diagram illustrating a display of the child machine according to an embodiment of the present invention. As shown in FIG. 8, on top of a screen of the child machine are attribute pages which are indicated by using names of the monitored main machines. The displayed monitored information page may be switched by a user through clicking on the names of the attribute pages by left-right keys or a touch pen. When there are a relatively large number of monitored main machines, there is a situation that a total width of the screen is less than a total width of the attribute pages. At this time, a multiple-page indicator may be displayed on two sides of the attribute pages, and the displayed monitored information page may be switched to the monitored information of another monitored main machine through relevant operations.

The inquiring module 704 is adapted to transmit a searching command to the monitored main machine and a request requesting the monitored main machine to return apparatus information of the main machine during a procedure of establishing the monitoring connection relationship with the monitored main machine, or transmit a monitored event inquiring list to the monitored main machine after the monitoring connection relationship is established with the monitored main machine.

The alarming module 705 is adapted to let out an alarm, e.g. a certain prompt sound or flickering light or shake, to prompt the user when receiving working status information or emergent event information returned by the monitored main machine.

Those skilled in the art should know that, in a simplest scenario, the child machine in this embodiment may include only the control module 701, the communication module 702 and the inquiring module 704.

FIG. 9 is a block diagram illustrating a structure of a main machine according to an embodiment of the present invention. As shown in FIG. 9, the main machine provided by this embodiment includes: a communication module 901, a detecting module 902 and a response control module 903. The three modules are electrically connected to each other.

The communication module 901 is adapted to establish a monitoring connection relationship with a child machine executing a monitoring task, transmit and receive information.

The detecting module 902 is adapted to detect whether there is a searching command transmitted by the child machine during a procedure of establishing the monitoring connection relationship with the child machine, or detect whether a monitored event inquiring list is received from the child machine or detect whether an emergent event happens in the main machine after the monitoring connection relationship with the child machine is established.

The response control module 903 is adapted to transmit apparatus information of the main machine to the child machine through the communication module 901 when the detecting module 902 detects a searching command transmitted by the child machine, inquire about and collect working status information of the main machine and transmit the working status information to the child machine through the communication module 901 when the detecting module 902 detects the monitored event inquiring list transmitted by the child machine, and transmit emergent event information to the child machine through the communication module 901 when the detecting module 902 detects an emergent event happens in the main machine.

According to the above embodiments of the present invention, although the main machine is monitored by the child machine, the child machine can monitor only pre-configured monitoring items but cannot monitor any other contents outside of the pre-configured monitoring items, i.e. the child machine cannot configure monitoring items by itself according to user's requirement.

Therefore, embodiments of the present invention further provide a method for dynamically configuring on a child machine a monitored event menu which matches a main machine.

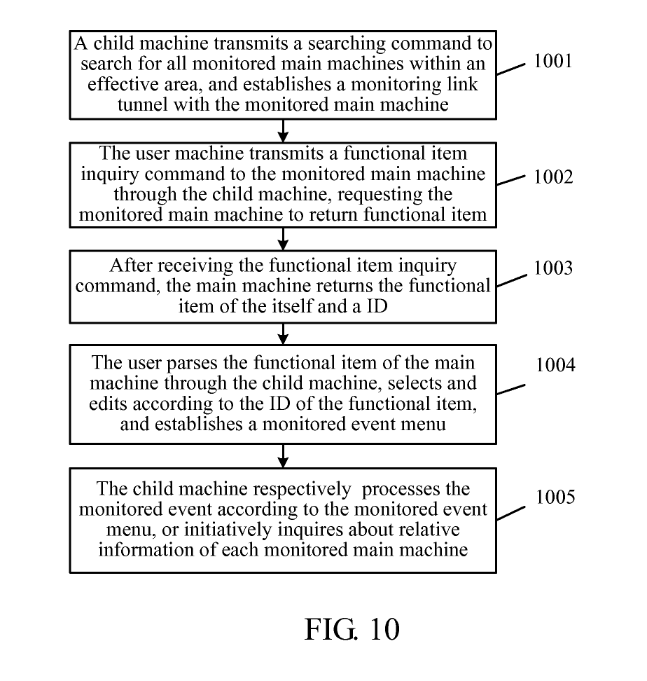

FIG. 10 is a flowchart illustrating a method for dynamically configuring a monitored event menu by a child machine according to an embodiment of the present invention. As shown in FIG. 10, the method includes the following steps.

Step 1001, a child machine transmits a searching command to search for all monitored main machines supporting a Customer ToolKit (CTK) within an effective area, and prepares to establish a matching monitoring link tunnel with each monitored main machine. The child machine records apparatus information of each monitored main machine in order to differentiate kinds and types of the monitored main machines.

Step 1002, the child machine transmits a functional item inquiry command to the monitored main machine according to a user's requirement, requesting the monitored main machine to return functional item information of the monitored main machine and an ID corresponding to the functional item.

The functional items need to be monitored may be different with respect to different kinds and types of the monitored main machines. For example, as to an intelligent cell phone, the functional items need to be monitored may be signal intensity, incoming call number, remained power, a new message, etc. As to a digital camera, the functional items need to be monitored may be storage space, remained power, etc. And as to a laptop, the functional items need to be monitored may be a new email, remained power, host storage space, etc.

In addition, the child machine may have no ability to monitor a functional item of the main machine beforehand due to its manufacture or edition. For example, the child machine may be unable to monitor a laptop about whether a new email is received by the laptop beforehand. Through transmitting an inquiry command to the monitored main machine, requesting the main machine to return its functional item need to be monitored and the ID corresponding the functional item, it is possible to add the monitoring item in the monitored event menu through editing a program in the child machine.

Step 1003, after receiving the functional item inquiry command, the monitored main machine collects functional items of the monitored main machine, generates a unique ID for each functional item, and returns the functional items and the IDs to the child machine after packaging the functional items and the IDs.

Step 1004, the child machine parses the received functional items of the monitored main machine, selects one or more functional items from the functional items of the monitored main machine to monitor, and establishes a monitored event menu according to the selected functional items. Each functional item may be selected according to the ID of the functional item.

For example, if the monitored main machine is a laptop, the monitored functional items and the IDs returned by the laptop may be as follows: ID 1000 denoting remained power of the laptop, ID 1002 denoting CPU temperature of the laptop, ID 1004 denoting email receiving functional item of the laptop. The child machine may select ID 1004 which denotes the email receiving functional item of the laptop, adds it to the child machine, and establishes a monitored event menu matching the laptop. At this time, a “laptop” monitoring page on the screen of the child machine displays a “receive email” menu option. The child machine records the ID corresponding to the functional item at the same time to recognize each functional item in the menu.

Step 1005, after the monitoring link tunnel is established, the child machine, according to the monitored event menu on the child machine, respectively processes monitored event reported by each monitored main machine and initiatively inquires about relevant information of the monitored main machine, so as to implement the monitoring task.

Through interacting with the monitored main machines, the child machine may configure different monitored event menus for different monitored main machines according to types and functions of the monitored main machines. The child machine may also configure different monitored event menus for the same monitored main machine with respect to different application scenarios.

After the monitored event menu is configured, the monitoring of the main machine by the child machine may be implemented in the main machine reporting manner and the child machine inquiring manner.

In this embodiment, since the ID is used for identifying each functional item, the child machine may transmit the ID corresponding to the functional item to be inquired about to the monitored main machine during the inquiry to the main machine. The monitored main machine collects information according to the ID received and returns the collected information to the child machine after packaging the collected data.

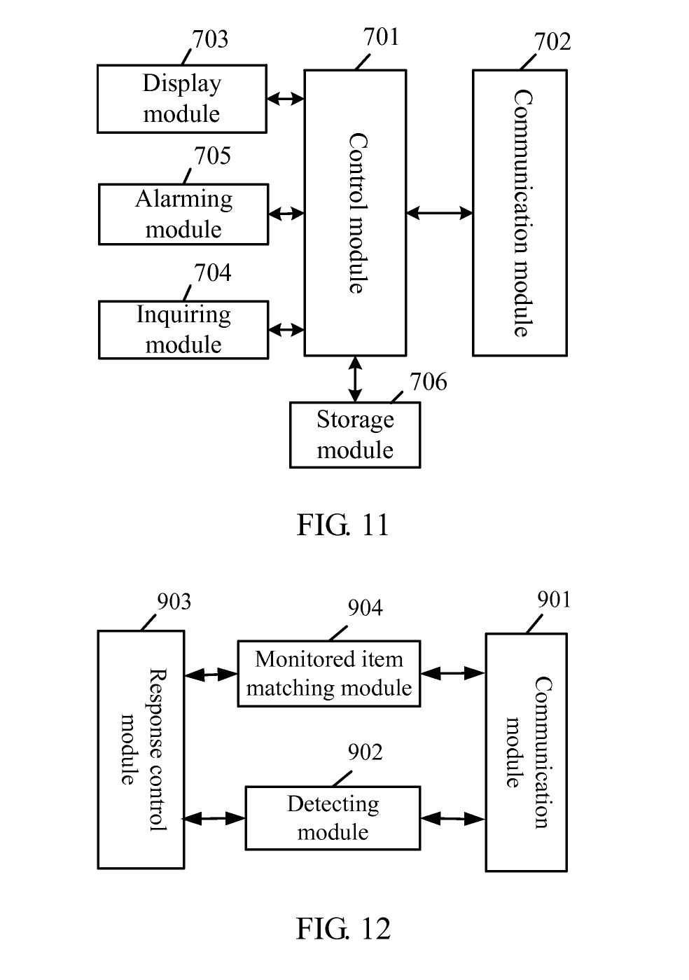

FIG. 11 is a block diagram illustrating a structure of a child machine according to an embodiment of the present invention. As shown in FIG. 11, the child machine provided by this embodiment includes: a control module 701, a communication module 702, a display module 703, an inquiring module 704, an alarming module 705 and a storage module 706. The control module 701, the communication module 702, the display module 703 and the alarming module 705 are the same with those corresponding modules in the child machine shown in FIG. 7. Compared with the child machine shown in FIG. 7, the inquiring module 704 is further adapted to transmit a functional item inquiry command to the monitored main machine, receive functional item returned by the monitored main machine, and configure a monitored event menu according to the functional item returned by the monitored main machine. The storage module 706 is adapted to store relevant information including the monitored event menu and monitoring data of each monitored main machine.

Certainly, the child machine in this embodiment may include the control module 701, the communication module 702, the display module 703, the inquiring module 704 and the alarming module 705 in the child machine shown in FIG. 7, and further includes a monitored event menu configuring module and the storage module 706. The monitored event menu configuring module is adapted to transmit the functional item inquiry command to the monitored main machine, receive the functional item returned by the monitored main machine, and configure the monitored event menu according to the functional item returned by the monitored main machine. The storage module 706 is adapted to store the relevant information including the monitored event menu and the monitoring data of each monitored main machine.

FIG. 12 is a block diagram illustrating a structure of a main machine according to an embodiment of the present invention. As shown in FIG. 12, the main machine provided by this embodiment includes: a communication module 901, a detecting module 902, a response control module 903 and a monitored item matching module 904. The communication module 901 and the response control module 903 are the same as corresponding modules shown in FIG. 9. The detecting module 902 is further adapted to detect whether a functional item inquiry command transmitted by a child machine is received. The monitored item matching module 904 is adapted to return functional items need to be monitored of the main machine to the child machine when the detecting module 902 receives the functional item inquiry command transmitted by the child machine, so as to cooperate with the child machine to complete the configuration of the monitored event menu.

In the method for monitoring a main machine by a child machine provided by the embodiments of the present invention, through performing a monitored menu matching configuration between the child machine and the main machine by using the CTK or software, a new functional item of the monitored main machine may be added in the monitored event menu of the child machine, which greatly enhances flexibility of the system operations and facilitates upgrade of system functions.

When the system for monitoring the main machine by the child machine provided by the above embodiments includes multiple child machines or multiple main machines, if only the child machines have the same function, each child machine is able to communicate with one main machine, which will brings out confusion. For example, one main machine may be controlled by an attacking child machine or may receive contrary operation commands from different child machines at the same time. In addition, a user may also expect to set permissions for different child machines. Therefore, embodiments of the present invention also provide a method of communication authentication between the child machine and the main machine. Through an authentication binding during a connection procedure between the main machine and the child machine, the child machine is granted with a certain functional permission. Thus, different child machines may obtain different authentications and implement different functions.

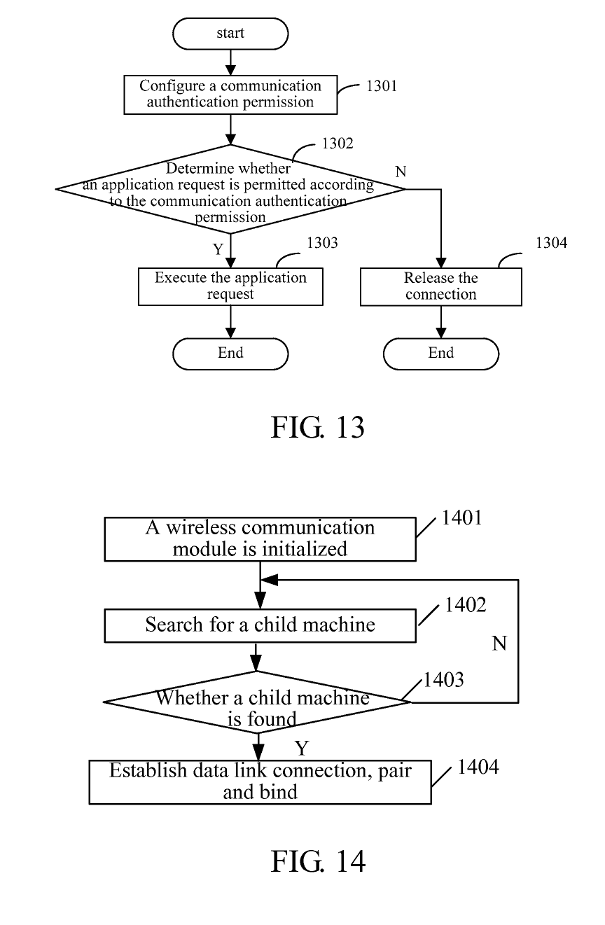

FIG. 13 is a flowchart illustrating a method of communication authentication between a main machine and a child machine according to an embodiment of the present invention. As shown in FIG. 13, the method of communication authentication between the main machine and the child machine includes the following steps.

Step 1301, a main machine configures communication authentication permission for a child machine.

Step 1302, the main machine determines whether an application request transmitted by the child machine to the main machine is permitted according to the communication authentication permission configured. If the application request is permitted, step 1303 is performed; otherwise, step 1304 is performed.

Step 1303, the main machine executes the application request transmitted by the child machine and ends the procedure.

Step 1304, the main machine releases a connection with the child machine and ends the procedure.

Before the main machine configures the communication authentication permission for the child machine, the method provided by this embodiment may further include: binding the child machine with the main machine and establishing a connection with the bound child machine by the main machine.

Specifically, the procedure of binding the main machine with the child machine may be initiated by the main machine or by the child machine. Hereinafter, the method that the main machine initiates the procedure of binding is described.

FIG. 14 is a flowchart illustrating a procedure of binding a main machine with a child machine according to an embodiment of the present invention. As shown in FIG. 14, the procedure of binding the main machine with the child machine includes the following steps.

Step 1401, a main machine initiates a wireless communication module, and prepares for a wireless communication connection between the main machine and the child machine.

Step 1402, the main machine searches for, within a certain area, a child machine which can establish a link key. The detailed procedure includes: the main machine initiates apparatus searching through initiatively transmitting a searching command. At this time, the child machine is in a state waiting for a searching command. Through the apparatus searching, the main machine is able to find the child machine within the effective area. During the searching procedure, the searching command does not contain any information of the main apparatus. But it is possible to designate two searching manners including Dedicated Inquiry Access Code (DIAC) and Global Information Assurance Certification (GIAC).

Step 1403, the main machine determines whether a child machine is found within the effective area. If a child machine is found, step 1404 is performed; otherwise, step 1402 is performed.

Since each apparatus has a global unique apparatus identification code, the main machine may search for the child machine within the effective area according to the apparatus identification code.

Step 1404, a user inputs a link key on the child machine. The main machine authenticates the child machine through checking the link key. The main machine determines whether the link key inputted by the user is correct. After the user inputted the correct key, the main machine successfully binds with the child machine. After the binding, anyone of the child machine and the main machine may initiate a connection request. There is no difference that whether it is initiated by the child machine and the main machine.

Herein, when firstly using the system including the main machine and the child machine, the user has to input a correct PIN code in the main machine to establish the link key.

During the procedure of binding initiated by the child machine, the child machine initiates a wireless communication module and prepares for a wireless communication connection between the main machine and the child machine. And the child machine initiatively searches for the main machine within a certain area.

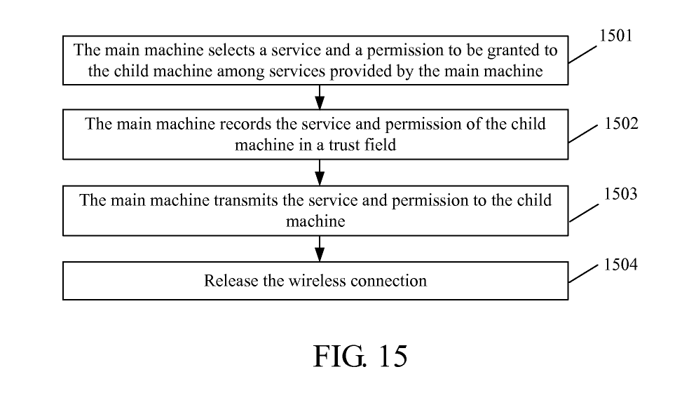

FIG. 15 is a flowchart illustrating configuring of communication authentication permission for a child machine by a main machine according to an embodiment of the present invention. As shown in FIG. 15, the procedure of configuring the communication authentication permission for the child machine by the main machine includes the following steps.

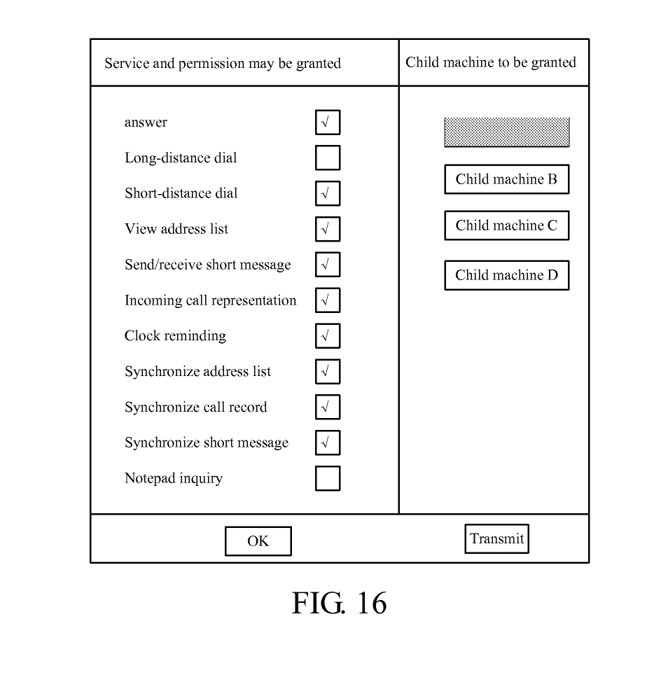

Step 1501, the main machine selects a service and permission to be granted to a child machine which is successfully bound with main machine. Those skilled in the art should know that, in practical applications, it is the user that selects the service and the permission granted to the child machine which is successfully bound with the main machine through the main machine. Therefore, in implementation, an interface may be configured for facilitating the user to select the service and the permission to be granted. An exemplary interface is as shown in FIG. 16.

Step 1502, the main machine generates a trust filed according to the selected service and permission for the child machine to record a relationship between the child machine and the service and permission possessed by the child machine. For example, a trust field 1 may record that a child machine 1 is able to dial, receive a call and send/receive a short message through the main machine; a child machine 2 can only send/receive a short message, while other similar wireless communication apparatuses can only exchange data or even can only transmit data to the main machine, etc. Thus, the main machine is able to determine whether a child machine possesses a certain service or permission according to the trust field.

The service and permission recorded in the trust field and may be granted by the main machine for the child machine include but are not limited to: dial, receive a call, send/receive a short message, incoming number representation, synchronizing contacts, short message, call record, event inquiry, clock reminding, etc.

Step 1503, the main machine transmits the service and the permission granted to the child machine to the child machine.

Step 1504, the main machine releases the connection with the child machine.

Hereinafter, the procedure of communication authentication between the main machine and the child machine is described in detail by taking that a child machine calls as an example.

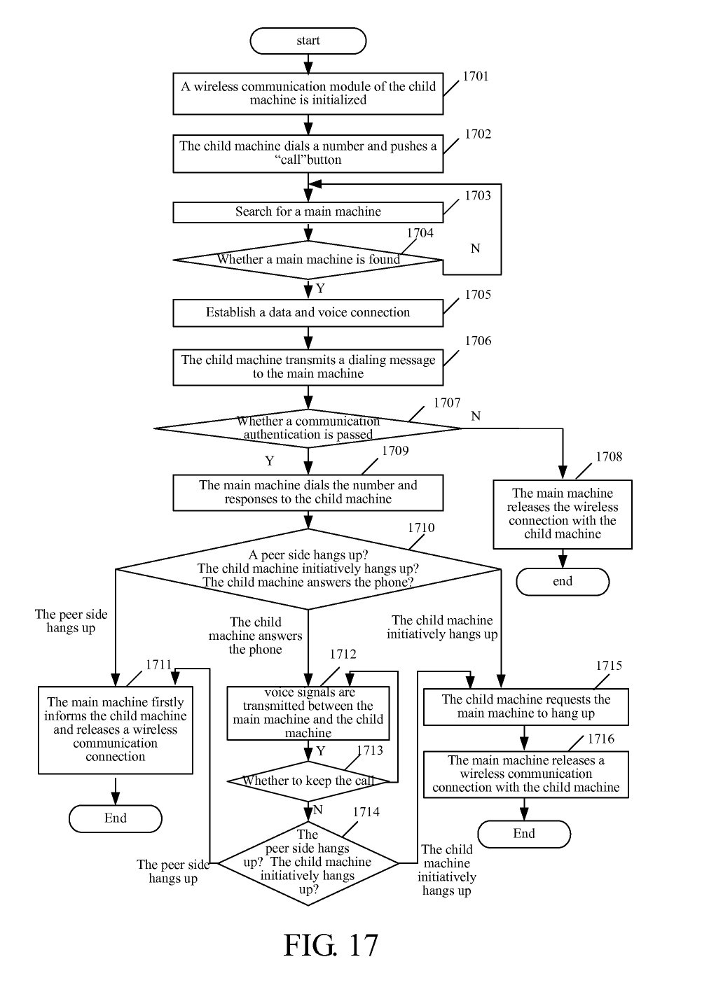

FIG. 17 is a flowchart illustrating a method of communication authentication between a child machine and a main machine during the calling of the child machine according to an embodiment of the present invention. As shown in FIG. 17, the communication authentication procedure between the main machine and the child machine includes the following steps.

Step 1701, a child machine initiates a wireless communication module, and prepares for a wireless communication connection between the child machine and a main machine.

Step 1702, the child machine inputs a telephone number through a keyboard, displays the telephone number on a screen, and pushes a “call” button.

Step 1703, the child machine searches for a main machine within a certain area. The child machine initiates an apparatus searching. The main machine performs a searching scan. Through the apparatus searching, the child machine is able to find the main machine bound with the child machine within the effective area.

Step 1704, the child machine determines whether a main machine bound with the child machine is found. If a main machine bound with the child machine is found, step 1705 is performed; otherwise, step 1703 is performed.

Step 1705, after finding the main machine bound with the child machine, the child machine establishes a data and voice connection with the main machine.

Step 1706, the child machine transmits an application request to the main machine to perform communication authentication. The child machine transmits dialing information to the main machine.

Step 1707, the main machine determines whether the application request transmitted by the child machine is recorded in a trust field of the main machine. If the trust field indicates that the child machine has a calling function, i.e. the application request transmitted by the child machine is recorded in the trust field of the main machine, step 1709 is performed; otherwise, step 1708 is performed.

Step 1708, the child machine does not have the calling authorization of the main machine and has no calling function. The main machine releases the wireless communication connection with the child machine and ends the procedure.

Step 1709, the main machine executes the application request of the child machine, dials the telephone number and delivers a calling status to the child machine for display in a response manner. Afterwards, at least three situations may occur, i.e. a peer side hangs up, the child machine answers the phone, and the child machine initiatively hangs up.

Step 1710, the main machine determines whether a current event is the peer side hanging up, or the child machine answering the phone or the child machine initiatively hanging up. If it is the peer side hanging up, step 1711 is performed; if it is the child machine answering the phone, step 1712 is performed; and if it is the child machine initiatively hanging up, step 1715 is performed.

Step 1711, the main machine informs the child machine that the peer side has already hung up, releases the wireless connection between the main machine and the child machine and ends the procedure.

Step 1712, voice signals are transmitted between the main machine and the child machine through their communication modules.

Step 1713, the main machine determines whether to keep the call. If it is determined to keep the call, step 1712 is performed; otherwise, step 1714 is performed.

Step 1714, the main machine determines whether it is the peer side or the child machine that hangs up. If it is the peer side that hangs up, step 1711 is performed; if it is the child machine that hangs up, step 1715 is performed.

Step 1715, the child machine requests the main machine to hang up.

Step 1716, the main machine releases the wireless communication connection with the child machine. Now, the procedure ends.

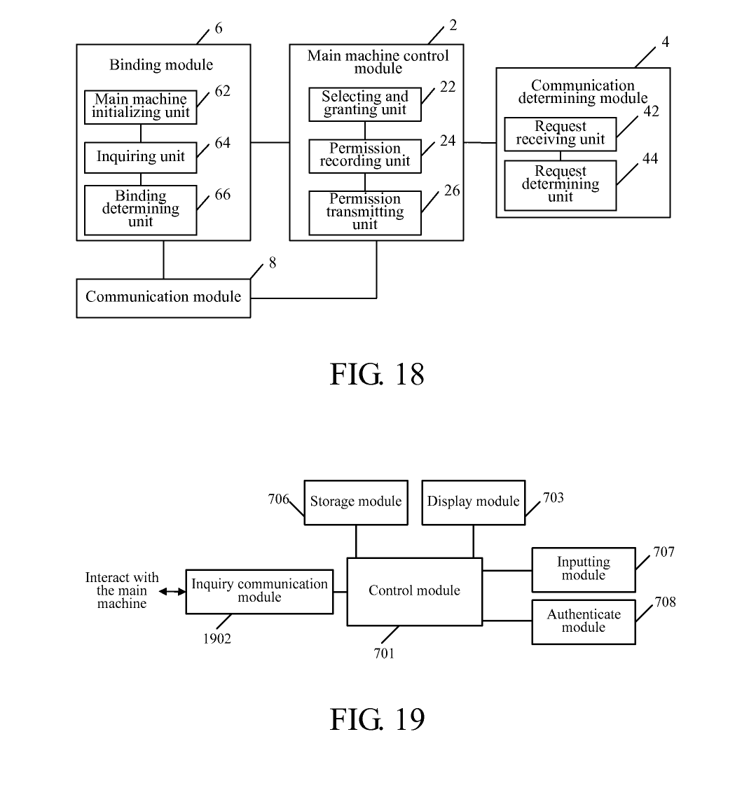

Accordingly, embodiments of the present invention provide a main machine. Through this main machine, it is possible to realize communication authentication between the main machine and the child machine. FIG. 18 is a block diagram illustrating a structure of a main machine according to an embodiment of the present invention. As shown in FIG. 18, the main machine includes a main machine controlling module 2 and a communication determining module 4. The main machine controlling module 2 includes a selecting and granting unit 22, a permission recording unit 24 and a permission transmitting unit 26 which are connected with each other. The communication determining module 4 includes a request receiving unit 42 and a request determining module 44 which are connected with each other.

The main machine controlling module 2 is adapted to configure communication authentication permission for a child machine which is successfully bound with the main machine. The selecting and granting unit 22 is adapted to select a service and permission to be granted to the child machine. The permission recording unit 24 is adapted to generate a trust field to record the service and permission selected for the child machine. The permission transmitting unit 26 is adapted to transmit the selected service and permission to the child machine.

The communication determining module 4 is adapted to determine whether an application request transmitted by the child machine is permitted by the communication authentication permission possessed by the child machine according to the communication authentication permission configured by the main machine controlling module 2 for the child machine, execute the application request if the application request is permitted, and release the connection with the child machine if the application request is not permitted. The request receiving unit 42 is adapted to receive the application request transmitted by the child machine. The request determining unit 44 is adapted to determine whether the application request transmitted by the child machine is permitted by the communication authentication permission possessed by the child machine according to the communication authentication permission configured by the main machine controlling module 2 for the child machine, execute the application request if the application request is permitted, and release the connection with the child machine if the application request is not permitted.

The main machine may further include a binding module 6 and a communication module 8. The binding module 6 includes a main machine initializing unit 62, a searching unit 64 and a binding determining unit 66.

The binding module 6 is adapted to bind the main machine with the child machine. The main machine initializing unit 62 is adapted to initialize a communication module and prepares for establishing a monitoring connection with the child machine. The searching unit 64 is adapted to search for a child machine within an effective area. The binding determining unit 66 is adapted to determine, when the searching unit 64 finds a child machine, whether to establish a link key connection with the found child machine according to a password inputted by a user, and bind the found child machine with the main machine if it is determined to establish the link key connection.

The communication module 8 is adapted to establish a communication connection with the child machine which is bound with the main machine.

Those skilled in the art should know that, the main machine in this embodiment may further include a response control module 903, a monitored item matching module 904 and a detecting module 902, and the function of the communication module 8 may be the same as that of the communication module 901.

Based on the main machine and the method of communication authentication between the main machine and child machine provided by the embodiments of the present invention, a trust field is established in the main machine, so as to configure different permissions for the child machine and other wireless communication modules. Thus, the child machine and the other wireless communication modules can communicate with the main machine only within the allowance of their permissions. Through setting permission for the child machine and making the child machine work within the allowance of the permission, interference among multiple child machines may be avoided. Meanwhile, the permission of the child machine may be modified through the main machine, which enhances flexibility.

Hereinafter, the method for monitoring a main machine by a child machine provided by the embodiments of the present invention is described by taking a cell phone as an exemplary main machine. Certainly, the following example is also applicable for situations where the main machine is a palm computer, or a PDA, or other mobile terminals having communication functions.

FIG. 19 is a block diagram illustrating a structure of a child machine for monitoring a status of a cell phone according to a first embodiment of the present invention. As shown in FIG. 19, the child machine includes a control module (a central processing module) 701, an inquiry communication module 1902, a display module 703, a storage module 706, an inputting module 707 and an authentication module 708.

The control module 701 is adapted to process various data information and data calculation, and process and execute an operation command inputted by a user through the inputting module 707.

The display module 703 is connected with the control module 701 and is adapted to output various status information of a cell phone obtained from the inquiry communication module 1902. The display module 703 may be a screen or in a voice playing apparatus, e.g. audio output apparatus.

The inputting module 707 is connected with the control module 701 and is adapted to input the operation command of the user to the control module 701. The inputting module 707 may be a keyboard, or a touch screen, or an audio inputting module.

The storage module 706 is connected with the control module 701 and is adapted to store data files. The storage module 706 may be a dynamic memory, a read-only memory or a static memory.

The authentication module 708 is connected with the control module 701 and is adapted to authenticate an identity of the cell phone when a communication connection is established between the cell phone and the child machine.

The inquiry communication module 1902 is connected with the control module 701 and is adapted to interact with the cell phone to obtain various status information or data of the cell phone. The inquiry communication module 1902 may include a wire communication module or a wireless communication module.

Those skilled in the art should know that, the inquiry communication module 1902 in this embodiment actually has the functions of the communication module 702 and the inquiring module 704 shown in FIG. 7.

When the inquiry communication module 1902 includes the wire communication module, the inquiry communication module 1902 may be a USB serial interface, a parallel interface or a network interface.

When the inquiry communication module 1902 includes the wireless communication module, the inquiry communication module 1902 is further connected with an antenna. Specifically, the inquiry communication module 1902 may adopt any communication protocol among 2.4G, 5.8G, DECT, GSM, GPRS, CDMA, TD-SCDMA and WCDMA. In practical product applications, a low power wireless communication module is most preferable, such as anyone of digital spreading technique, UWB, Wi-Fi, IrDA, NFC and ZigBee. Thus, radiation hurts to human bodies may be reduced at the most.

In the child machine provided by the embodiment of the present invention, each module may be an independent module, or the modules may be one integrated module.

Based on the child machine provided by the embodiment of the present invention, it is possible to read status information of the cell phone through the inquiry communication module 1902, and display the status information of the cell phone for the user through the display module 703. Meanwhile, the user is able to control the cell phone through the inputting module 707, e.g. answering a call or dialing a number, reading or replying to a short message, creating a new calendar, etc.

Those skilled in the art should know that, the child machine in the above embodiment may include, in a simplest scenario, only the control module 701, the inquiry communication module 1902, the display module 703 and the inputting module 707. Or, the child machine may include only the control module 701, the inquiry communication module 1902, the display module 703, the inputting module 707 and the authentication module 708. Or, the child machine may include only the control module 701, the inquiry communication module 1902, the display module 703, the storage module 706 and the inputting module 707.

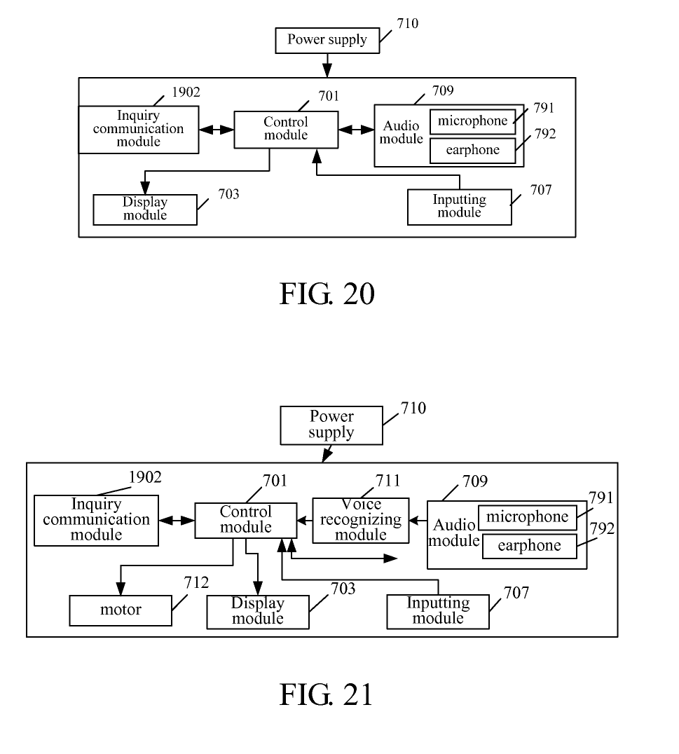

FIG. 20 is a block diagram illustrating a structure of a child machine for monitoring a status of a cell phone according to a second embodiment of the present invention. As shown in FIG. 20, besides a control module (also referred to as a main control module) 701, a inquiry communication module 1902 (specifically, may be a short-distance transmission/reception module), a display module 703 and an inputting module 707, the child machine further includes a power supply 710 and an audio module 709.

The power supply 710 is adapted to provide power for the control module 701, the inquiry communication module 1902, the display module 703, the inputting module 707 and the audio module 709 in the child machine and implement a charging function. In implementation, the power supply 710 may adopt a power supply management mode such as Low Drop Out (LDO) or Direct Current/Direct Current (DC/DC).

The audio module 709 is adapted to receive voice information of a user, transmit the voice information of the user to the control module 701 for processing, so as to transmit the voice information to the main machine through the inquiry communication module 1902, receive a voice signal from the main machine through the inquiry communication module 1902 and the control module 701, and output the voice signal to the user.

The audio module 709 includes a microphone 791 and an earphone 792. During work, the audio signal from the microphone 791 is transmitted out by the inquiry communication module 1902 after being processed by the control module 701. The inquiry communication module 1902 receives an audio signal from the main machine, demodulates the audio signal under control of the control module 701 and outputs to the user via the earphone 792.

FIG. 21 is a block diagram illustrating a structure of a child machine for monitoring a status of a cell phone according to a third embodiment of the present invention. As shown in FIG. 21, besides including the circuit structure shown in FIG. 20, extended functions are configured for the child machine. A voice recognizing module 711 is configured between the microphone 791 and the control module 701 for recognizing voice information inputted by the audio module 709 to realize identity identification of the user. The child machine may further be configured with a motor 712 when required. The motor 712 is connected with the control module 701 and is adapted to shake under control of the control module 701. When there is an audio signal or a control signal is returned to the child machine from the main machine through the inquiry communication module 1902, the motor may shake to remind the user. Those skilled in the art should know that, the motor 712 may be an example of the alarming module 705.

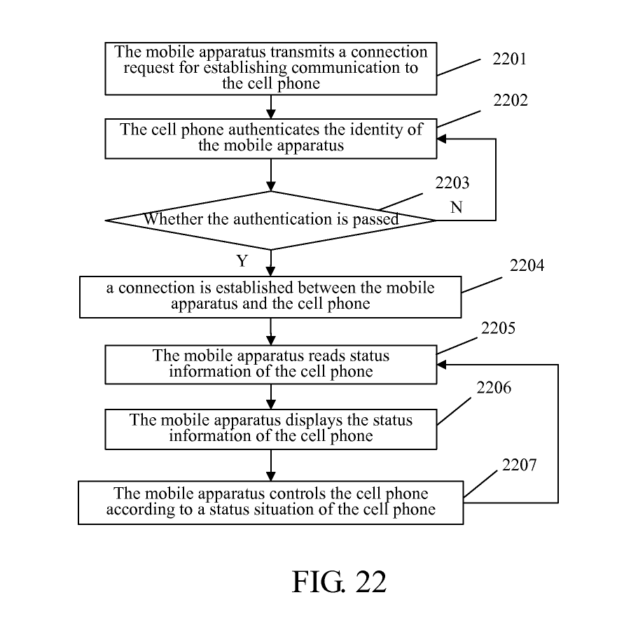

FIG. 22 is a flowchart illustrating a method for monitoring a status of a cell phone according to a first embodiment of the present invention. As shown in FIG. 22, a child machine for monitoring the status of the cell phone is referred to as a mobile apparatus. The method includes the following steps.

Step 2201, the mobile apparatus transmits a connection request for establishing communication to the cell phone.

Step 2202, after receiving the connection request of the mobile apparatus, the cell phone authenticates the identity of the mobile apparatus.

Step 2203, the cell phone determines whether the mobile apparatus passes the authentication, if the mobile terminal apparatus passes the authentication, step 2204 is performed; otherwise, step 2201 is performed and re-authentication is request.

Step 2204, a communication connection is established between the mobile apparatus and the cell phone.

Step 2205, the mobile apparatus read status information of the cell phone. The mobile apparatus may read the status information of the cell phone at regular times according to a parameter configured by the user or after receiving a cell phone trigger signal (e.g. a trigger signal transmitted when a call comes or a short message is received).

The status information of the cell phone includes a communication function state and an information state. The communication function state includes a call-incoming state and a short message state. The information state includes calendar reminding, journey reminding, clock reminding, power supply prompt, network state, storage space state, notepad, contact and call record.

It should be noted that, if it is the first time that the communication connection between the mobile apparatus and the cell phone is established, the mobile apparatus needs to read all status information of the cell phone.

Step 2206, the mobile apparatus displays the status information of the cell phone through a display module of the mobile apparatus.

Step 2207, the user operates the cell phone through the mobile apparatus according to the status information of the cell phone, e.g. perform communication function operations such as answering a call or dialing a number, sending/receiving a short message, or perform information function operations such as creating a calendar, a journey or a contact.

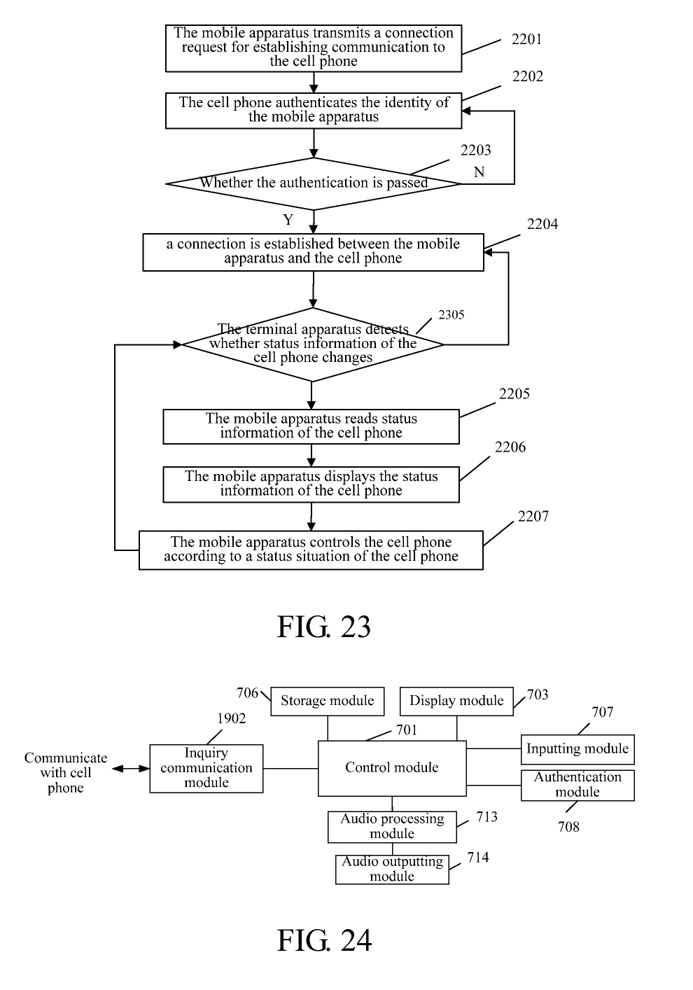

FIG. 23 is a flowchart illustrating a method for monitoring a status of a cell phone according to a second embodiment of the present invention. As shown in FIG. 23, the difference between this embodiment and that shown in FIG. 22 only relies in that, a trigger situation that the mobile apparatus read the status information of the cell phone is different. i.e., a step 2305 is further included between steps 2204 and 2205. Other steps are the same as those in FIG. 22.

Step 2305, the mobile apparatus detects whether the status of the cell phone changes. If the status of the cell phone changes, step 2205 is performed; otherwise, step 2204 is performed.

In an embodiment of the present invention, the apparatus for monitoring the status of the cell phone may be a multimedia player. At this time, besides the modules shown in FIG. 19, the apparatus should further include a multimedia playing functional component. FIG. 24 is a block diagram illustrating a structure of a multimedia player for monitoring a status of a cell phone according to an embodiment of the present invention. As shown in FIG. 24, the multimedia player includes not only the modules shown in FIG. 19 but also an audio processing module 713 and an audio outputting module 714.

The audio processing module 713 is connected with the control module 701 and is adapted to perform encoding/decoding processing to an audio signal. The audio processing module 713 may include an audio encoder/decoder, adapted to perform the encoding/decoding processing to a multimedia file such as an audio, and may further include a digital/analogy convertor, adapted to realize conversion between digital signals and analogy signals. In order to achieve better voice effect, the audio processing module 713 may further include an audio amplifying module, adapted to amplify the audio analogy signals.

The audio processing module 713 may be an independent module or be integrated with other modules, e.g. integrated in the control module 701. In the embodiment shown in FIG. 20, the audio processing module may be integrated in the control module 701.

The audio outputting module 714 is connected with the audio processing module 713 and is adapted to output the audio signal encoded or decoded by the audio processing module 713. The audio outputting module 714 may be a reproducer, the earphone 792, or an audio interface such as an earphone interface.

Thus, when the user uses the multimedia player to answer a call, voice signals (audio/video signals) from a peer side are transmitted to the inquiry communication module 1902 of the multimedia player through the cell phone, and then are transmitted to the audio outputting module 714 after being processed by the control module 701 and the audio processing module 713, and finally are transmitted to the user.

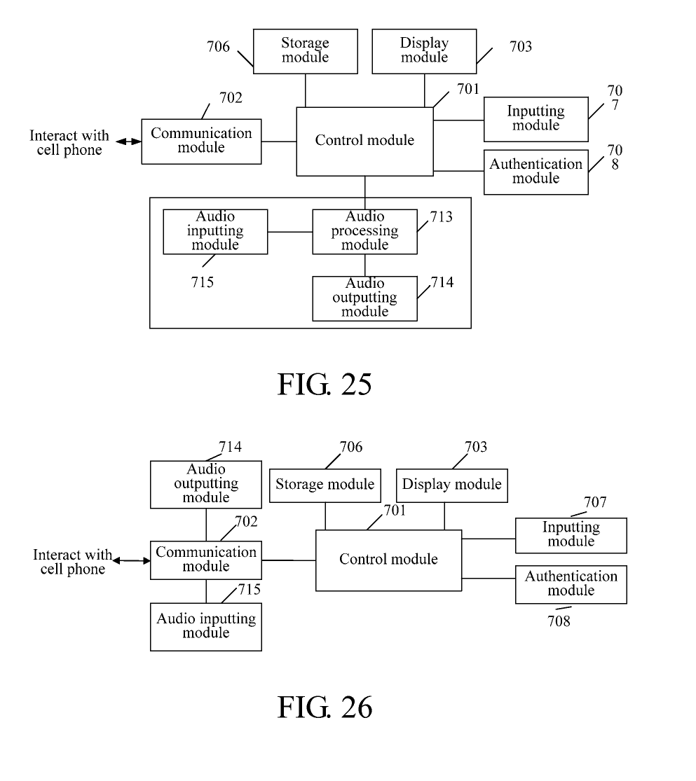

FIG. 25 is a block diagram illustrating a structure of a multimedia player according to a second embodiment of the present invention. As shown in FIG. 25, compared with the multimedia player shown in FIG. 24, this multimedia player further includes an audio inputting module 715 which is connected with the audio processing module 713 and is adapted to receive audio/video signals inputted by the user and transmit the audio/video signals to the inquiry communication module 1902 after being processed by the audio processing module 713.

Thus, the user can not only receive cell phone information through the multimedia player but also transmit voice information to other users through the audio inputting module 715. At this time, the voice signals (audio/video signals) transmitted by the user are transmitted to the audio processing module 713 for processing through the audio inputting module 715, and transmitted to the inquiry communication module 1902 through the control module 701, and then transmitted to the cell phone by the inquiry communication module 1902, and finally transmitted to the other users.

FIG. 26 is a block diagram illustrating a structure of a multimedia player according to a third embodiment of the present invention. As shown in FIG. 26, if a communication module which integrates an audio processing function is adopted as the inquiry communication module 1902, the audio processing module 713 is not required any more. The audio inputting module 715 and the audio outputting module 714 are both connected with the inquiry communication module 1902. At this time, voice signals (audio/video signals) transmitted by the user is transmitted to the inquiry communication module 1902 through the audio inputting module 715, and then are transmitted to the cell phone through the inquiry communication module 1902, and finally transmitted to the peer side. Voice signals from the peer side are also required to be processed by the inquiry communication module 1902 before being transmitted out to the audio outputting module 714.

The player connects with the cell phone in a wire manner to implement data interaction with the cell phone. The user can hang the player around his/her neck or put it in a pocket of his/her coat. And it is also very convenient for the user to monitor the status of the cell phone accurately and to control the cell phone through the inputting module if the cell phone is put in a bag or a pocket of his/her trousers. In addition, through performing operations such as answering a phone or calling a number via the player, radiation hurts of the cell phone signals to human body is greatly reduced.

When the above technical solution is adopted, the size of the multimedia player may be very small. A cell phone user may put the multimedia player near his/her head, e.g. hang around the neck or put in a pocket of a coat, to enjoy music through the multimedia player. At the same time, the player establishes a communication connection with the cell phone through the inquiry communication module 1902, read status information of the cell phone and displays the status information of the cell phone through the display module 703. The cell phone user is able to control the cell phone through the inputting module 707, e.g. answering a phone or calling a number, reading or replying to a short message, creating a new calendar, etc.

The above only takes the voice service as an example. With development of communication services, video services (such as video telephone) are also widely applied. Therefore, the above examples do not mean that the present invention is only applicable for voice services. It is also applicable for video services. It is only required to replace the audio processing module 713 and the audio inputting module 715 by an audio/video processing module and audio/video inputting module.

In one embodiment of the present invention, the audio module shown in FIG. 20 may consist of the audio processing module 713 and the audio outputting module 714 shown in FIG. 24, or consist of the audio processing module 713, the audio outputting module 714 and the audio inputting module 715 shown in FIG. 25, or consist of only the audio inputting module shown in FIG. 26.

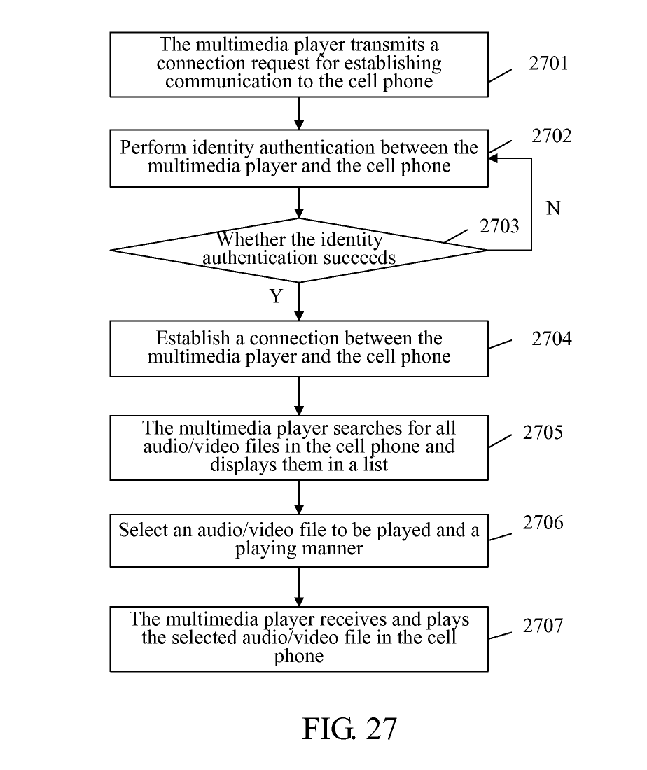

FIG. 27 is a flowchart illustrating a method for monitoring a cell phone and playing an audio/video file of the cell phone by a multimedia player according to an embodiment of the present invention. As shown in FIG. 27, the method for monitoring the cell phone and playing the audio/video file of the cell phone by the multimedia player includes the following steps.

Step 2701, the multimedia player transmits a connection request for establishing communication to the cell phone after receiving an operation command for sharing and playing an audio/video file in the cell phone.

Step 2702, after receiving the connection request from the multimedia player, the cell phone requests to perform an identity authentication.

Step 2703, if the multimedia player passes the identity authentication of the cell phone, step 2704 is performed; otherwise, step 2702 is performed and the cell phone requests to perform the identity authentication again; or the authentication may be closed, the procedure is ended and a new connection request is required to be initiated.

Step 2704, a communication connection is established between the cell phone and the multimedia player.

Step 2705, the multimedia player searches for all audio/video file information in the cell phone and displays all audio/video file information in a list. At this time, the audio/video files may be arranged according to their audio/video format types or according to their file names.

Step 2706, the multimedia player selects, according to a user's selection, an audio/video file to be played which is stored in the cell phone; a single file or multiple files may be selected. Meanwhile, a playing manner may also be selected, e.g. playing all or selected audio/video files automatically and sequentially, or playing them circularly.

Step 2707, the multimedia player receives and plays the above selected audio/video files. At this time, the multimedia player may receive and play the multimedia file of the cell phone in a real-time streaming manner. The audio/video file is played once being received and buffered. The receiving and the playing are performed in parallel. Or, the audio/video file may be played after being completely received by the multimedia player and stored in a buffer, memory or storage module of the multimedia player.

It should be noted that, the selection of the audio/video file to be played in step 2706 is optional. If step 2706 is not executed, the multimedia player plays, after the communication connection is established, the audio/video files which are stored in the cell phone and searched out by the multimedia player one by one.

The above method brings out an advantage that the multimedia player can share and play multimedia files shorted in the cell phone. Thus, even if the multimedia player has a very little storage space, it can share and play a larger amount of audio/video information stored in the main machine such as the cell phone.

It should be noted that, in practical applications, the multimedia player and the cell phone in the embodiments of the present invention are not necessarily to be produced or sold together. The multimedia player and the cell phone are two kinds of independent products. Users can respectively purchase a cell phone and a multimedia player produced by different manufactures. A monitoring and controlling relationship can be established as long as a communication connection between them is established.

Certainly, the method is also applicable in a larger range, i.e. the child machine may share all resources such as text information, audio and video of the main machine being monitored by the child machine.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

What is claimed is:

1. A method for monitoring a main machine, comprising:
paging by a monitoring apparatus, a main machine within an effective area, receiving, by the monitoring apparatus, from a main machine being paged, apparatus information of the main machine;
determining at least one main machine as a monitored main machine according to the apparatus information returned by the at least one main machine;
establishing a monitoring connection relationship with each monitored main machine; and
monitoring an emergent event of the at least one monitored main machine or inquiring about a working status of the at least one monitored main machine, by using the monitoring connection relationship established.

2. The method of claim 1, wherein the monitoring the emergent event of the at least one monitored main machine or inquiring about the working status of the at least one monitored main machine by using the monitoring connection relationship established comprises:
according to monitored functional item information of each monitored main machine, monitoring the emergent event corresponding to the monitored functional item information of each monitored main machine or inquiring about the working status corresponding to the monitored functional item information of each monitored main machine.

3. The method of claim 1, wherein the monitoring the emergent event of the at least one monitored main machine or inquiring about the working status of the at least one monitored main machine by using the monitoring connection relationship is performed in a main machine reporting manner or a monitoring apparatus inquiring manner.

4. The method of claim 3, wherein the monitoring the emergent event of the monitored main machine in the main machine reporting manner comprises:
receiving an emergent event transmitted from the monitored main machine;
display the emergent event transmitted from the monitored main machine to a user;
receiving a process result of the user to the emergent event; and
returning the process result to the monitored main machine.

5. The method of claim 3, wherein inquiring about the working status of the monitored main machine in the monitoring apparatus inquiring manner comprises:
transmitting a monitored event inquiring list to the monitored main machine, wherein the monitored event inquiring list comprises monitored functional item information; and
receiving working status information transmitted from the monitored main machine, wherein the working status information is collected by the monitored main machine according to the monitored event inquiring list received.

6. The method of claim 2, before monitoring the emergent event of the monitored main machine corresponding to the monitored functional item information or inquiring about the working status of the monitored main machine corresponding to the monitored functional item information according to the monitored functional item information of the monitored main machine, the method further comprises:
transmitting a functional item inquiry command to the monitored main machine, requesting the monitored main machine to return the functional item information of the monitored main machine;
receiving the functional item information of the monitored main machine transmitted by the monitored main machine; and
selecting one or more items from the functional item information transmitted by the monitored main machine, and taking the selected one or more items of the functional item information as the monitored functional item information.

7. The method of claim 6, wherein the receiving the functional item information of the monitored main machine transmitted by the monitored main machine comprises:
receiving the functional item information and an ID uniquely corresponding to each piece of function item information transmitted by the monitored main machine;
the selecting one or more items from the functional item information transmitted by the monitored main machine comprises:
selecting one ore more items of the functional item information transmitted by the monitored main machine according to the ID uniquely corresponding to each piece of functional item information.

8. The method of claim 6, further comprising:
providing a man-machine interface for a user to display the emergent event or the working status corresponding to the monitored functional item information of the at least one monitored main machine.

9. The method of claim 1, wherein the monitoring the emergent event of the at least one monitored main machine or inquiring about the working status of the at least one monitored main machine is performed under communication authentication permission granted for the monitoring apparatus by the at least one monitored main machine.

10. The method of claim 9, wherein the communication authentication permission granted to the monitoring apparatus comprises at least one service and permission selected by the monitored main machine.

11. The method of claim 9, further comprising: recording, by the monitored main machine, a relationship between the monitoring apparatus and the communication authentication permission granted for the monitoring apparatus;
when receiving an application request transmitted by the monitoring apparatus, determining, by the monitored main machine, according to the relationship between the monitoring apparatus and the communication authentication permission granted for the monitoring apparatus, whether the application request transmitted by the monitoring apparatus is permitted by communication authentication permission granted for the monitoring apparatus, if the application request is permitted, executing the application request transmitted by the monitoring apparatus; otherwise, releasing the monitoring connection relationship with the monitoring apparatus;
wherein the application request is adapted to monitor the emergent event of the monitored main machine or inquire about the working status of the monitored main machine.

12. The method of claim 1, wherein the monitoring apparatus is a multimedia player; and the method further comprises: the multimedia player searching for audio/video files in the monitored main machine, receiving the audio/video files from the monitored main machine and playing the audio/video files.

13. The method of claim 12, further comprising:
after searching out the audio/video files in the monitored main machine, the multimedia player selecting one or more audio/video files from the audio/video files searched out according to a user's selection;
wherein the receiving the audio/video files from the monitored main machine and playing the audio/video files comprises:
receiving the one or more audio/video files selected from the monitored main machine and playing the one or more audio/video files selected.

14. A monitoring apparatus, comprising: a control module, a communication module and an inquiring module; wherein
the control module is adapted to control communication between the communication module and the inquiring module;
the communication module is adapted to establish a monitoring connection relationship with a monitored main machine; and
the inquiring module is adapted to transmit, during establishment of the monitoring connection relationship with the monitored main machine, a searching command and a request requesting the monitored main machine to return apparatus information of the monitored main machine to the monitored main machine, and adapted to monitor, after the monitoring connection relationship is established with the monitored main machine, an emergent event of the monitored main machine or inquire about a working status of the monitored main machine.

15. The monitoring apparatus of claim 14, further comprising:
a display module, adapted to display working status information or emergent event information returned by the monitored main machine.

16. The monitoring apparatus of claim 14, further comprising:
an alarming module, adapted to let out an alarm to remind a user when receiving the working status information or the emergent event information returned by the monitored main machine.

17. The monitoring apparatus of claim 14, further comprising:
a monitored event menu configuring module, adapted to transmit a functional item inquiry command to the monitored main machine, receive functional item information returned by the monitored main machine, and configure a monitored event menu for the monitored main machine according to the functional item information returned by the monitored main machine; and
the inquiring module is further adapted to monitor the emergent event of the monitored main machine or inquire about the working status of the monitored main machine according to the monitored event menu of the monitored main machine configured by the monitored event menu configuring module.

18. The monitoring apparatus of claim 14, further comprising:
a storage module, adapted to store the monitored event menu and monitored data of the monitored main machine.

19. The monitoring apparatus of claim 14, further comprising:
an inputting module, adapted to input an operation command of a user and transmit the operation command to the control module; and
the control module is further adapted to perform information processing for the operation command inputted by the user through the inputting module.

20. The monitoring apparatus of claim 14, further comprising:
an authentication module, adapted to perform an identity authentication to the monitored main machine when establishing the communication connection with the monitored main machine.

21. The monitoring apparatus of claims 14, further comprising:
an audio module, adapted to receive voice information inputted by a user, transmit the voice information inputted by the user to the control module for processing, transmit processed voice information to the monitored main machine through the communication module, and output voice information which is received by the communication module and processed by the control module to the user.

22. The monitoring apparatus of claim 14, further comprising:
a power supply, adapted to provide power to each module in the monitoring apparatus monitoring apparatus.

23. A main machine, comprising: a communication module, a detecting module and a response control module; wherein
the communication module is adapted to establish a monitoring connection relationship with a monitoring apparatus performing a monitoring task;
the detecting module is adapted to detect, during establishment of the monitoring connection relationship with the monitoring apparatus, whether a searching command is transmitted by the monitoring apparatus, and adapted to detect, after the establishment of the monitoring connection relationship with the monitoring apparatus, whether a monitored event inquiring list is received from the monitoring apparatus or whether there is an emergent event happens in the main machine; and
the response control module is adapted to transmit apparatus information of the main machine to the monitoring apparatus through the communication module when the detecting module detects the searching command transmitted by the monitoring apparatus, inquire about and collect working status information of the main machine and transmit the working status information to the monitoring apparatus through the communication module when the detecting module detects that the monitored event inquiring list is received from the monitoring apparatus, or transmit emergent event information to the monitoring apparatus through the communication module when the detecting module detects that the emergent event happens in the main machine.

24. The main machine of claim 23, further comprising:
a monitored item matching module, adapted to return a functional item needs to be monitored to the monitoring apparatus when the detecting module detects a functional item inquiry command transmitted by the monitoring apparatus, to cooperate with monitoring apparatus to implement configuration of a monitored event menu; and
the detecting module is further adapted to detect whether the functional item inquiry command is received from the monitoring apparatus.

25. The main machine of claim 23, further comprising:
a main machine controlling module, adapted to configure communication authentication permission for the monitoring apparatus;
a communication determining module, adapted to determine whether an application request transmitted by the monitoring apparatus is permitted by the communication authentication permission possessed by the monitoring apparatus according to the communication authentication permission configured by the main machine controlling module for the monitoring apparatus, execute the application request transmitted by the monitoring apparatus if the application request is permitted, and release the monitoring connection relationship with the monitoring apparatus if the application request is not permitted.

26. The main machine of claim 25, further comprising:
a binding module, adapted to bind the main machine with the monitoring apparatus.

27. The main machine of claim 25, wherein the main machine controlling module comprises:
a selecting and granting unit, adapted to select a service and permission to be granted to the monitoring apparatus;
a permission recording unit, adapted to generate a trust field according to the service and permission selected by the selecting and granting unit for the monitoring apparatus to record the service and permission selected for the monitoring apparatus;
a permission transmitting unit, adapted to transmit the service and permission selected for the monitoring apparatus to the monitoring apparatus.

28. The main machine of claim 26, wherein the binding module comprises:
a main machine initializing unit, adapted to initialize the communication module;
a search unit, adapted to search for the monitoring apparatus within an effective area; and
a binding determining unit, adapted to determine, if the search unit finds the monitoring apparatus, whether to establish a link key connection with the monitoring apparatus according to a key inputted by a user, and bind the main machine with the monitoring apparatus if it is determined to establish a link key connection.
